(19) United States
(12) Patent Application Publication
(10) Pub. No.: US 2025/0274988 A1
(43) Pub. Date: Aug. 28, 2025

(54) SYSTEMS AND METHODS FOR TRANSMISSION TIMING INDICATION

(71) Applicant: ZTE CORPORATION, Shenzhen (CN)

(72) Inventors: Xing LIU, Shenzhen (CN); Junfeng ZHANG, Shenzhen (CN); Xianghui HAN, Shenzhen (CN); Shuai ZHOU, Shenzhen (CN)

(73) Assignee: ZTE CORPORATION, Shenzhen (CN)

(21) Appl. No.: 19/208,871

(22) Filed: May 15, 2025

Related U.S. Application Data
(63) Continuation of application No. PCT/CN2023/087112, filed on Apr. 7, 2023.

(51) Int. Cl. H04W 74/0833; H04L 27/26; H04L 43/0864

(52) U.S. Cl. CPC H04W 74/0833; H04L 27/2607; H04L 43/0864

(57) ABSTRACT

The present arrangement relates to systems, methods, and non-transitory computer-readable media for transmission timing indication. The method may include receiving, from a network, two or more groups of transmission resources for a random access procedure; determining that a first random access procedure performed using a first transmission resource in a first group of resources has failed; and performing a second random access procedure using a second transmission resource in a second group of transmission resources.

### CROSS-REFERENCE TO RELATED APPLICATION

This application claims the benefit of priority under 35 U.S.C. § 120 as a continuation of PCT Patent Application No. PCT/CN2023/087112, filed on Apr. 7, 2023, the disclosure of which is incorporated herein by reference in its entirety.

### TECHNICAL FIELD

The disclosure relates generally to wireless communications and, more particularly, to physical random access channel (PRACH).

### BACKGROUND

In 5^{th} Generation Mobile Network System (5GC), PRACH is a key technology in new radio (NR) systems. PRACH format designs may include cyclic prefix (CP).

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

In some arrangements, two or more groups of transmission resources is received. A wireless communication device can receive, from a network, the two or more groups of transmission resources for at least one random access procedure. The wireless communication device can determine that a first random access procedure performed using a first transmission resource in a first group of transmission resources of the two or more groups has failed. In response to determining that the first random access procedure has failed, the wireless communication deice can perform, with the network, a second random access procedure using a second transmission resource in a second group of transmission resources of the two or more groups.

In some arrangements, two or more groups of transmission resources is sent. A network can send, to a wireless communication device, the two or more groups of transmission resources for at least one random access procedure, where the wireless communication device fails to perform a first random access procedure using a first transmission resource in a first group of transmission resources of the two or more groups. The network can perform, with the wireless communication device, a second random access procedure using a second transmission resource in a second group of transmission resources of the two or more groups.

In some arrangements, two or more timing advancement (TA) commands is received. A wireless communication device can receive, from a network, the two or more TA commands for at least one random access procedure. The wireless communication device can determine a first transmission time of an uplink transmission in a first random access procedure according to a first TA command of the two or more TA commands.

In some arrangements, a TA command and at least one offset value is received. A wireless communication device can receive, from a network, the TA command and the at least one offset value corresponding to the TA command. The wireless communication device can determine a first transmission time of an uplink transmission in a first random access procedure according to the TA command. The wireless communication device can determine that the first random access procedure using the first transmission time has failed. In response to determining that the first random access procedure has failed, the wireless device can determine a second transmission time of the uplink transmission in a second random access procedure according to the TA command and the at least one offset value.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 illustrates a scheme implemented for supporting transmission timing indication, according to various arrangements.

FIG. 4 is a diagram illustrating an example physical random access channel (PRACH) format, according to various arrangements.

FIG. 5 is a diagram illustrating an example wireless communication including PRACH, according to various arrangements.

FIG. 6 is a diagram illustrating an example PRACH mapping, according to various arrangements.

FIG. 7 is a diagram illustrating an example wireless communication method, according to various arrangements.

FIG. 8 is a diagram illustrating an example wireless communication method, according to various arrangements.

FIG. 9 is a diagram illustrating an example wireless communication method, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system, a wireless device may communicate with a network. As part of the communication process, the wireless device may communicate physical random access channel (PRACH). In some cases, a PRACH format design may consider a cyclic prefix (CP) length (e.g., included in the PRACH) to be less than a threshold length (e.g., one orthogonal frequency division multiplexing (OFDM) symbol). However, the threshold length may limit coverage of a network node (e.g., a base station). To extend PRACH coverage, a portion of preambles of the PRACH (e.g., resources of the preambles) may be used as supplementary CP (e.g., some forepart preambles may be used as the CP). However, when a base station detects the PRACH, due to different locations of wireless devices during transmission, multiple round trip delay (RTD) values may be associated with the PRACH, which may cause the base station to be unable to determine a time resource for when the PRACH begins, determine a timing advance (TA) adjustment amount for a UE, receive a Msg3 (e.g., of a random access channel (RACH) procedure), or any combination thereof.

The arrangement disclosed herein provides enhancements (e.g., additions, updates, changes) to PRACH procedures, for example, how to determine an RTD value for a PRACH transmission of multiple RTD values. To do so, wireless communications systems may be configured with mappings between value ranges of RTD or TA commands and PRACH groups. For example, a wireless communication device may select multiple TA command values for determining transmission timing of Msg3 physical uplink shared channel (PUSCH) by switching PRACH transmission resources among groups. Additionally, or alternatively, more than one TA commands may be indicated via a random access response (RAR). The wireless device can try multiple values of TA command for determining the transmission timing.

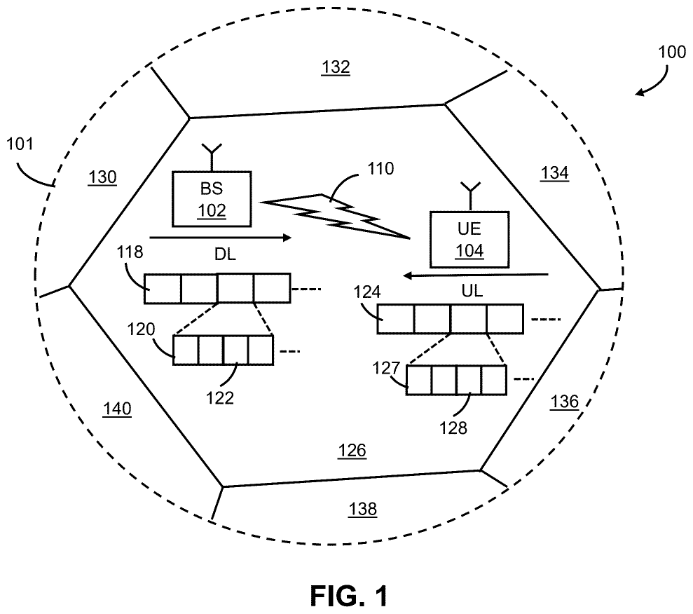

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

In some implementations, the wireless communication system 100 may support MIMO communication. For example, MIMO is a key technology in new radio (NR) systems. MIMO may be functional in both frequency division duplex (FDD) and time division duplex (TDD) systems, among others. MIMO technologies may utilize reporting mechanisms such as CSI to support communication. CSI reports may include various types, parts, groups, and fields. The techniques described herein may provide enhancements to various aspects of the CSI report and reporting process. For example, a wireless communication device may receive, by a wireless communication device from a network, multiple reference signals and a configuration parameter. The wireless communication device may determine a CSI report based on the multiple reference signals and the configuration parameter, where the CSI report comprises CSI part 1 and CSI part 2. The wireless communication device may report, to the network, the CSI report. In some cases, the reporting process may include one or more of the following: the configuration parameter may be configured for enabling two or more CQIs in the CSI report, the reference signals are aperiodic or semi-persistent, and each of a CSI window length, DD basic unit size, an offset between two CSI reference signal (CSI-RS) resources, and a length of DD basic vector is larger than or equal to a threshold. Additionally, or alternatively, the wireless communication device may send, to the network, a User Equipment (UE) capability report indicating that the wireless communication device supports a number of CQI reports, where the number is a positive integer. The wireless communications system may implement codebooks to further support CSI reporting, among other various uses.

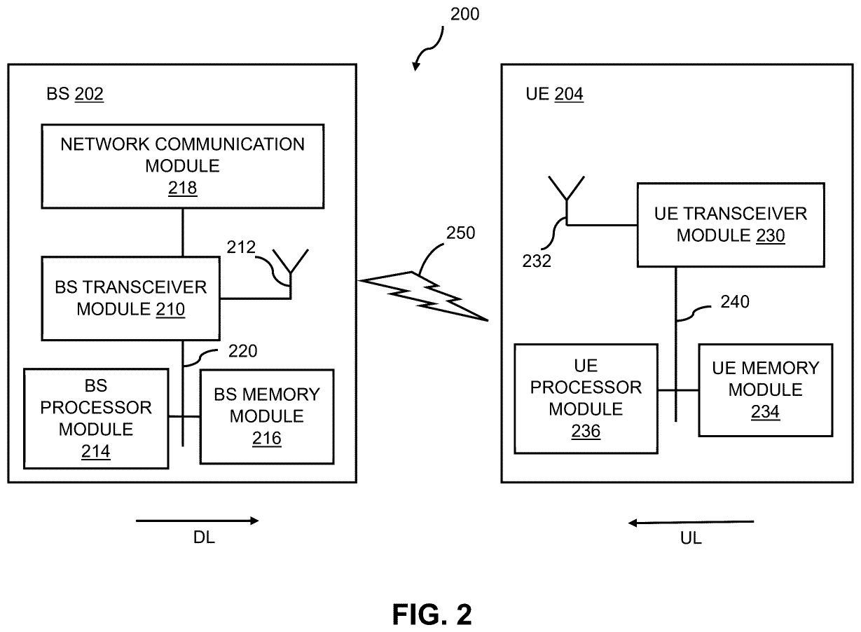

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

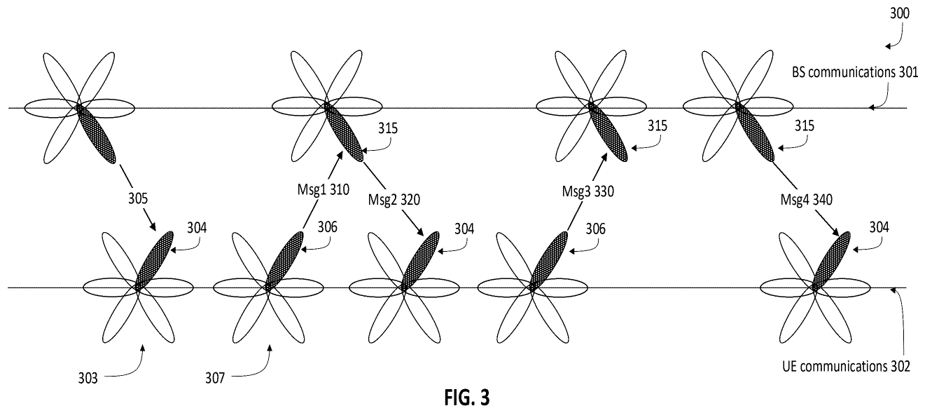

FIG. 3 illustrates an example scheme 300 implemented for supporting the initial access (e.g., PRACH procedure) under frequency ranges FR1 (e.g., sub-6G Hz band) and frequency range FR2 (e.g., beyond 6G Hz band). In FIG. 3, the base station communications 301 (e.g., beamforming) of a base station (e.g., the base station 102, 202) can be shown on the top rail while UE communications 302 (e.g., beamforming) of a UE (e.g., the UE 104, 204) can be shown on the bottom rail. The transmission of PRACH for example can be transmitted via Msg1 310. The scheme 300 further includes different PRACH formats, PRACH resource configurations, the relationship between the Synchronization Signal/Physical Broadcasting Channel (PBCH) Block (SSB) and PRACH occasion, the mechanism of PRACH retransmission, the mechanism of PRACH power control, and so on.

The shaded beams in FIG. 3 are beams used to transmit or receive data. As shown in FIG. 3, the UE transmits a preamble in PRACH Occasion (RO), according to the configuration of PRACH transmission and a selected SSB. In transmitting the preamble in RO, if the transmit-receive correspondence on the UE-side can be guaranteed, a fixed mapping between the UE's receiving (Rx) beam and the UE's transmitting (Tx) beam can be used. A unique Tx beam can be determined according to its receiving of the SSB. For example, the UE can attempt to use different Rx beams 303 to receive the SSB from the base station (e.g., at 305), and determine the best Rx beam 304.

In some arrangements, the best Rx beam 304 (e.g., the best downlink Rx beam) is a beam with the highest Reference Signal Received Power (RSRP) or with an RSRP value higher than a predefined threshold. According to the best Rx beam 304, the best Tx beam 306 (e.g., best uplink Tx beam) is determined based on beam correspondence. The RO used for transmitting the PRACH is determined according to the relationship between the SSB and PRACH occasion. Based on the relationship, the base station can determine the SSB selected by the UE. The same beam 315 can be used for transmitting subsequent downlink transmissions, including, Msg2 320 (which can also be referred to as RAR) and Msg4 340 (e.g., a Physical Downlink Shared Channel (PDSCH) with UE contention resolution identity). According to a RACH procedure, the RAR (e.g., Msg2 320) is transmitted in response to receiving a PRACH transmission (e.g., Msg1 310). The UE can monitor a RAR Physical Downlink Control Channel (PDCCH) within a RAR window, which starts at the first symbol of the earliest Control Resource Set (CORESET) for which the UE is configured to receive the PDCCH for Type1-PDCCH Common Search Space (CSS) set that is at least a predefined number of time units (e.g., symbols) after the last symbol of the PRACH occasion corresponding to the PRACH transmission. When a UE receives a RAR PDCCH in the RAR window (e.g., a downlink control information (DCI) format 1-0 with cyclic redundancy check (CRC) scrambled by a random access radio network temporary identifier (RA-RNTI), is detected), the UE may send a Msg3 330 PUSCH to the base station according to a RAR uplink (UL) grant in the RAR (e.g., RAR contents). For example, the Msg3 330 PUSCH may be scheduled by the RAR UL grant in the RAR. The transmission timing of Msg3 330 PUSCH may also be indicated in the RAR.

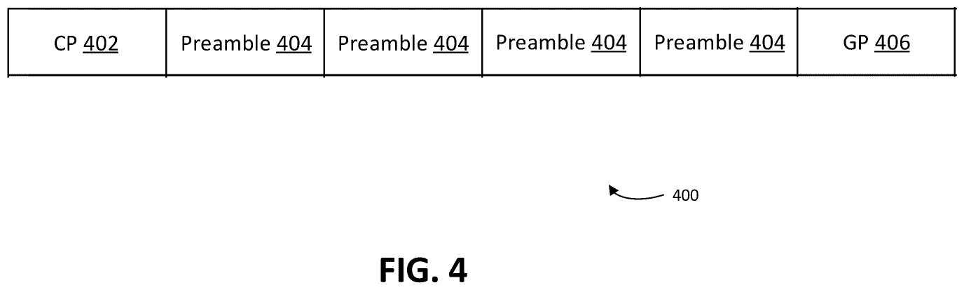

FIG. 4 is a diagram illustrating an example PRACH format 400, according to various arrangements. The format 400 may include a CP 402, multiple preambles 404, and a guard period (GP) 406. In some cases, a length of the CP 402 may be defined to not exceed a length of one OFDM symbol (e.g., 2048κ·2^{-μ}). However, the length of one OFDM symbol may limit coverage of the PRACH transmission to a base station. For example, a PRACH format used in millimeter (mm) wave band to support fixed wireless access (FWA) may support a CP length of one OFDM symbol. For subcarrier spacing (SCS) equaling, for example, 120 KHz, the CP length can support up to approximately 1.15 km cell radius (e.g., less than some FWA scenarios). However, some FWA scenarios may use up to 10 km transmission distance between a base station and a UE.

In some cases, to extend the coverage area, the preambles 404 may be used. For example, a portion of the preambles 404 may be used to supplement the CP 402 (e.g., a base station may determine (e.g., pretend) that some forepart of the preambles 404 may be a part of the CP 402). However, if a base station detects a PRACH that supports supplementing the CP 402 with the a portion of the preambles 404, then the base station may determine multiple possible CP length values. Based on a location of a UE being served by the base station, multiple RTD values may be possible. If the base station is unable to determine which RTD value to use for a TA adjustment among, a wrong transmission timing for further communication (e.g., Msg3) may be indicated, and a RACH procedure may fail. For example, the base station fails to receive the Msg3 PUSCH, which is transmitted according to a wrong transmission timing.

In some implementations, a RACH occasion (RO) may be a time-frequency domain transmission resource of a PRACH transmission. The time domain resource of the PRACH transmission may be configured via radio resource control (RRC) signaling (e.g., prach-ConfigurationIndex). The index may map to a line in a table of random access configurations (e.g., the index may be a value from 0 to 255, where the table has 256 lines and indicates a preamble format). For example, a portion of the table may be represented by Table 1.

TABLE 1
Random Access Configurations

| | | | | | | | Nₜ^{RA, slot} | |
|---|---|---|---|---|---|---|---|---|
| | | | | | | | number | |
| | | | | | | | of time- | |
| | | | | | | | domain | |
| | | | | | | Number of | PRACH | |
| | | | | | | PRACH | occasions | |
| PRACH | | | | | | slots | within a | N_{dur}^{RA}, |
| Configuration | Preamble | n_{f} mod x = y | | Subframe | Starting | within a | PRACH | PRACH |
| Index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 4 | 1 | 1 | 0 | — | — | 0 |
| 9 | 0 | 4 | 1 | 4 | 0 | — | — | 0 |

. . .

The frequency domain resource of the PRACH transmission may be configured via RRC signaling. For example, the signaling may include a msg1-FrequencyStart field that indicates a frequency starting resource block within a carrier and a msg1-FDM field that indicates a number of RACH transmission resources that are frequency division multiplexed (FDM).

In some cases, a resource for PRACH transmission (e.g., RO) may be determined. For example, the RO may be determine based on the time and frequency domain resource configuration. In some cases, whether the RO is a valid RO can be determined according to one or more of the following. If a UE is provided tdd-UL-DL-ConfigurationCommon, a PRACH occasion in a PRACH slot is valid. If the RO is within UL symbols, or the RO does not precede either a synchronization signal block (SSB) or a physical broadcast channel (PBCH) block in the PRACH slot and starts at least N_{gap} symbols after a last downlink symbol and at least N_{gap} symbols after a last SSB/PBCH block symbol, where N_{gap} is provided in Table 2. For some preamble formats (e.g., B4), N_{gap}=0. A PRACH format may be transmitted within an RO.

TABLE 2
N_{gap} Value for Different Preamble SCS μ

| Preamble SCS | N_{gap} |
|---|---|
| 1.25 kHz or 5 kHz | 0 |
| 15 kHz or 30 kHz or 60 kHz or | 2 |
| 120 kHz | |
| 480 kHz | 8 |
| 960 kHz | 16 |

The format 400 may include six symbols. For example, a same preamble 404 may be repeated four times and cascaded together. Each of the preambles 404 may occupy same quantity of resources (e.g., 2048κ·2^{-μ}). For example, if μ=0 (Δf_{RA}=15·2^{μ} kHz) then 2048κ·2^{-μ}≈0.06667 ms. The CP 402 with a length of 2048κ·2^{-μ} may precede the preambles 404, and the remaining portions of the 6 symbols may be the GP 406 (e.g., 2912κ·2^{-μ}≈0.09479 ms). The given example may include the following calculations: the constant κ=Tₛ/T_{c}=64, where Tₛ=1/(Δf_{ref}·N_{f,ref}) and where Δf_{ref}=15·10³ Hz and N_{f,ref}=2048; and T_{c}=1/(Δfₘₐₓ·N_{f}) where Δfₘₐₓ=480·10³ Hz and N_{f}=4096.

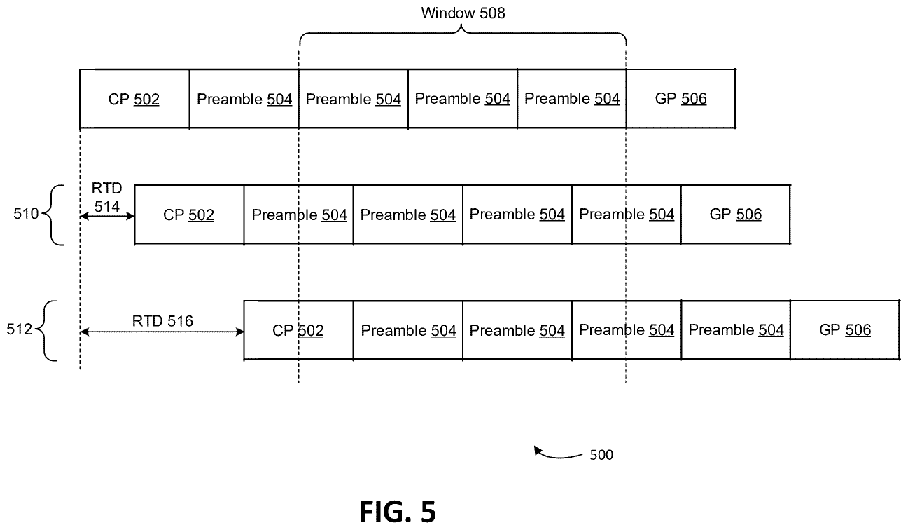

FIG. 5 is a diagram illustrating an example wireless communication 500 including PRACH, according to various arrangements. The wireless communication 500 may include communication of a PRACH. The PRACH may include symbols occupied according to a PRACH format. For example, a first part with length of 2048κ·2^{-μ} (e.g., about one symbol) may be occupied by a CP 502, a second part with length of 4*2048κ·2^{-μ} (e.g., about four symbols) may be occupied be repeating preambles 504, and a third part with length of 2912 k·2^{-μ} may be occupied by a GP 506. In some cases, a first PRACH transmission 510 may be associated with a first RTD 514 and a second PRACH transmission 512 may be associated with a second RTD 516 (e.g., based on distance of UEs transmitting the transmissions 510 and 512 from a base station).

Some wireless communication systems may support a base station detecting PRACH. For example, a base station may detect a PRACH during a detection window. The detection window may cover four preambles (e.g., a time zone including four preambles) of the PRACH. In some cases, reception status may depend on distance. For example, if a UE is near a base station, an RTD may equal zero. If the UE is in the middle of the zone of coverage (e.g., a cell) of the base station, then the RTD may be between zero and one CP length. If the UE is located at an edge of the cell, then the RTD may equal the CP length. If the UE is outside of the cell, then the RTD may be greater than the CP length and the extra delay may cause PRACH detection to fail. To enhance coverage, CP length may be addressed.

In some cases, the wireless communication 500 may support extending coverage of a base station. For example, the base station may determine (e.g., pretend) that a portion of the preambles 504 may be a part of the CP 502. For example, if SCS equals 120 KHz, one CP length can support up to about 1.15 km cell radius; one CP length plus one preamble length can support up to about 2.3 km cell radius; one PC length plus two preamble length can support up to about 3.45 km cell radius; one CP plus three preamble length can support up to about 4.6 km cell radius. For other PRACH formats that support more preambles (e.g., format B4 with one CP and twelve preambles) greater cell radii may be possible (e.g., 13.13 km cell radius with twelve preambles).

In some cases, during random access procedures, a base station that supports extending coverage via PRACH preambles may detect PRACH at various times (e.g., detect PRACH associated with multiple possible RTDs). For example, if the base station supports the CP length including the CP 502 and one of the preamble 504, the base station may detect a first transmission 510 with an RTD 514 or a second transmission 512 with an RTD 516 greater than the RTD 514 during the detection window 508. However, the base station may fail to determine a validity of the RTD 514 and the RTD 516 in a first step of a random access procedure. For example, the base station may be unable to determine which RTD 514 or 516 to apply to which transmission 510 or 512. If the base station uses a wrong RTD (e.g., applying the RTD 514 to the transmission 512), then the base station may determine an inaccurate TA adjustment amount for the UE (e.g., transmitted in a TA command included in a RAR). The UE may transmit a Msg3 according to the TA command, however, due to the inaccurate TA adjustment, the base station may not receive (e.g., decode) the Msg3 correctly, and the random access procedure may fail.

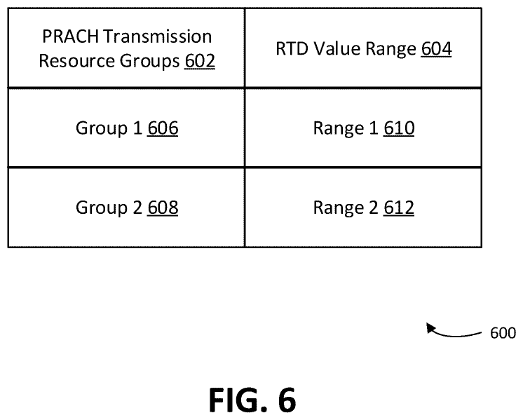

FIG. 6 is a diagram illustrating an example PRACH mapping 600, according to various arrangements. The mapping 600 may include a PRACH transmission resource groups column 602 and an RTD value range column 604. Each PRACH resource group or list may be associated with (e.g., map to) a range of RTD values. For example, a first group 606 may be associated with an RTD value within a range 610 greater than zero and less than or equal to one CP length (e.g., 0.06667 ms in the example under PRACH format C2 with 15 kHz). A second group 608 may be associated with an RTD value within a range 612 greater than one CP length (e.g., 0.06667 ms in the example under PRACH format C2 with 15 kHz) and less or equal to a sum of one CP length plus one preamble length (e.g., the sum can be 0.13333 ms in the example under PRACH format C2 with 15 kHz).

In some cases, the mapping 600 may be associated with a method to determine a value in a plurality of RTD estimation results. For example, a UE may be configured with two or more PRACH transmission resource groups or lists for at least one random access procedure (e.g., the UE may receive, and a base station may send, the two or more PRACH transmission resources). The UE may select a first PRACH transmission resource from a first group for initiating a RACH procedure. If the RACH procedure fails, the UE may switch to another group (e.g., may select a second PRACH transmission resource from a second group) for reinitiating the RACH procedure (e.g., performing another RACH procedure between the UE and the base station). For example, a UE may receive two or more groups (e.g., groups 606 and 608) of PRACH transmission resources. The UE may select a PRACH transmission resource within the group 606 to initiate a RACH procedure. If the RACH procedure fails (e.g., the UE fails to receive Msg4 after transmitting Msg3), then the UE may select a PRACH transmission resource within the group 608 (e.g., switch to the group 608) to initiate a RACH procedure (e.g., reinitiate the RACH procedure, perform a second RACH procedure).

In some examples, each PRACH transmission resource group may be associated with (e.g., map to) value ranges of RTD (e.g., a round-trip transmission time between the UE and the base station) or TA commands (which is to indicate the transmission timing of subsequent UL transmission, e.g., Msg3 PUSCH). For example, the group 606 may be associated with an RTD value within a range 610 of zero to one CP length. The group 608 may be associated with an RTD value within a range 612 of one CP length to one CP length plus one preamble length. For example, if Δf_{RA}=15 kHz with a PRACH format of six symbols, a length of a CP part of the PRACH transmission may be 2048κ·2^{-μ}=0.06667 ms and the length of the CP plus one preamble may be 4096κ·2^{-μ}=0.13333 ms.

In some examples, the PRACH transmission resources may include at least one of an RO resource or a preamble resource. For example, a PRACH transmission resource can be at least one of an RO resource or a preamble resource. Different PRACH transmission resource groups (e.g., groups 606 and 608) may be different feature combinations, where same RO resources with separate preamble resources may be used by different PRACH transmission resource groups. In some cases, different RACH configurations (e.g., RACH-Config) may be used to configure different RO resources for different PRACH transmission resource groups.

In some embodiments, a UE may select at least one of the groups 606 or 608 based on one or more measurement thresholds (e.g., synchronization signal reference signal received power (SS-RSRP)). For example, the threshold may be configured (e.g., defined) to the UE for determining the PRACH transmission resource group in which a PRACH transmission resource should be selected. For example, if the PRACH transmission resource groups 602 includes the groups 606 and 608 and one measurement threshold is configured, then, if the measurement result is lower than or no greater than the measurement threshold, the group 606 may be determined, and a PRACH transmission resource may be selected from the group 606 for initiating the RACH procedure. Otherwise, if the measurement result is no lower than or greater than the measurement threshold, the group 608 may be determined, and a PRACH transmission resource may be selected from the group 608 for initiating the RACH procedure.

In some embodiments, if a UE selects a PRACH transmission resource from the group 606 for initiating a RACH procedure, but the RACH procedure fails, the UE may switch to another group (e.g., the group 608). For example, determining a RACH procedure failure may include at least one of, determining that a number of times that the RACH procedure has failed reaches a threshold, determining that a transmission power used for the RACH procedure reaches a threshold, determining that a repetition factor for a PRACH transmission used for the RACH procedure reaches a threshold, and/or determining that the UE has failed to detect a DCI format with a CRC scrambled by a temporary cell radio network temporary identifier (TC-RNTI) or an RA-RNTI after the UE transmitted a PUSCH scheduled by a RAR uplink grant.

If the UE determines that the transmission power used for the RACH procedure reaches the threshold, the UE can use a PRACH transmission resource used for the RACH procedure to initiate the next RACH procedure with a higher transmission power. For example, a power ramping counter (e.g., PRACH PREAMBLE_POWER_RAMPING_COUNTER) may be incremented by one (e.g., for calculating the PRACH transmission power) and the RACH procedure reinitiated. If the transmission power of the PRACH transmission reaches a maximum transmission power (e.g., an allowed transmission power, a UE capability transmission power), and the RACH procedure fails, the UE may switch to another group (e.g., select another PRACH transmission resource from another group for reinitiating the RACH procedure). In some examples, the transmission power of the first PRACH transmission after group switching can be calculated as the first PRACH transmission (e.g., the power ramping counter can be reset after group switching).

If the UE determines that a first repetition factor (e.g., a repetition factor equal to two) for a PRACH transmission used for the RACH procedure reaches a threshold, the UE can reinitiate the RACH procedure with a PRACH repetition factor greater than the first repetition factor (e.g., repetition factor=4). If the repetition factor of the PRACH transmission reaches a maximum value (e.g., repetition factor=8, a UE capability threshold), and the RACH procedure fails, the UE may switch to another group (e.g., select another PRACH transmission resource from another group for reinitiating the RACH procedure). In some examples, the repetition factor may be determined according to a relationship between the SS-RSRP measurement result and an SS-RSRP threshold.

In some embodiments, if a base station detects a PRACH, the base station can determine which PRACH transmission group the detected PRACH belongs to. Further, the base station can determine an RTD value or TA command range for a UE associated with the PRACH according to a relationship (e.g., a mapping) between the PRACH transmission resource group and the RTD value or TA command range. An RTD or TA command value can be determined from the determined RTD value or TA command range. In case that the RTD or TA command value is a wrong value (e.g., the RACH procedure fails), another value can be determined based on the UE initiating another RACH procedure by selecting a PRACH transmission resource from another PRACH transmission resource group, which may result in an increased coverage for base stations using PRACH transmissions.

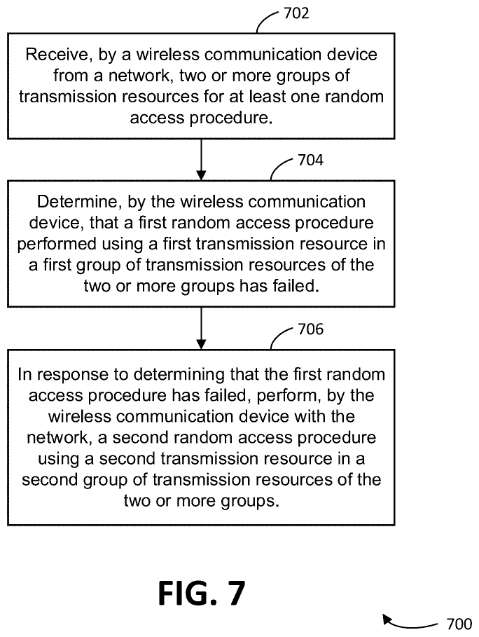

FIG. 7 is a flowchart diagram illustrating an example wireless communication method 700, according to various arrangements. In some cases, the method 700 may include configurations for a wireless communication device to receive two or more groups of transmission resources.

At 702, a wireless communication device may receive, from a network, two or more groups of transmission resources for at least one random access procedure. At 704, the wireless communication device may determine that a first random access procedure performed using a first transmission resource in a first group of transmission resources of the two or more groups has failed. At 706, in response to determining that the first random access procedure has failed, the wireless device may perform, with the network, a second random access procedure using a second transmission resource in a second group of transmission resources of the two or more groups.

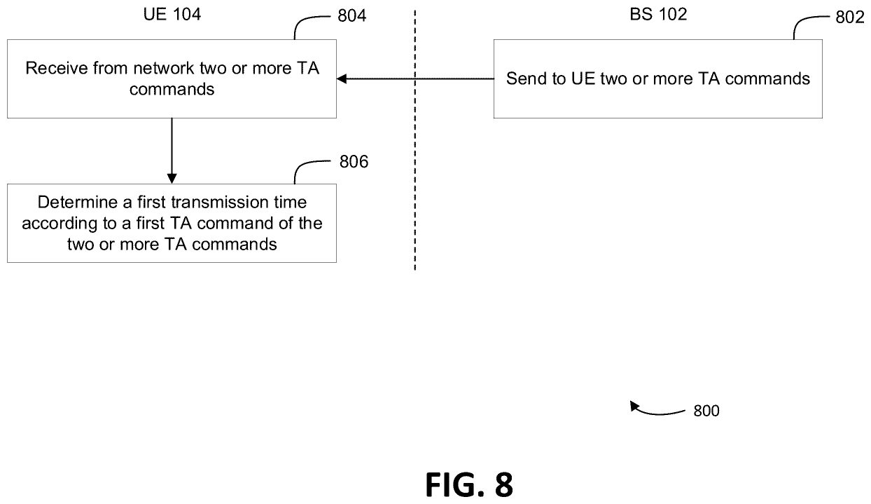

FIG. 8 is a diagram illustrating an example wireless communication method 800. The method 800 may include communications between a UE 104 and a base station (BS) 102. In some cases, the method 800 may include configurations for the UE 104 to receive two or more TA commands. If the UE 104 can determine more than one TA command value, the UE 104 may transmit more than one Msg3 PUSCH before receiving a Msg4.

In some cases, a UE may transmit a PRACH and may determine a TA for a Msg3 PUSCH transmission (e.g., determine a transmission timing for Msg3 PUSCH) based on a TA command. In some embodiments, two or more TA commands can be included in a RAR. For example, at 802, the BS 102 may send, to the UE 104, two or more TA commands for at least one random access procedure. The BS 102 may send the TA commands in a RAR. At 804, the UE 104 may receive, from the network, the two or more TA commands. At 806, the UE 104 can determine a first transmission timing for a Msg3 PUSCH according to a first TA command of the TA commands. If the RACH procedure fails then the UE 104 may adjust (e.g., determine) a second transmission timing of the Msg3 PUSCH according to a second TA command of the TA commands to retransmit the Msg3 PUSCH. In some cases, determining that the RACH procedure failed may include the UE 104 failing to receive a message (e.g., Msg4) from the network within a time window (e.g., a time interval after the UE 104 transmits the Msg3 PUSCH for determining transmission failure).

In some embodiments, a TA command with a shortest potential value and one or more offsets between the shortest value and each of one or more other potential values of TA command can be indicated in the RAR or a system information block (SIB). The UE 104 can first determine the transmission timing of the Msg3 PUSCH according to the shortest value of the TA command. If the RACH procedure fails, the UE 104 may adjust the transmission timing of the Msg3 PUSCH according to another TA command (e.g., to retransmit the Msg3 PUSCH). The other TA command may be calculated (e.g., derived) by adding one of the offsets and the shortest potential TA command value.

In some embodiments, the Msg3 PUSCH repetition may be configured. For example, the UE 104 may determine transmission timing of the Msg3 PUSCH according to one of the TA commands. A repetition factor of the Msg3 PUSCH transmission may equal two. If the UE 104 fails to receive a Msg4 before the repetition factor satisfies the threshold (e.g., two), the UE 104 can re-transmit the Msg3 PUSCH with the same transmission timing and a greater repetition factor than the previous repetition factor (e.g., repetition factor=4). If the repetition factor of the Msg3 PUSCH transmission reaches a maximum value (e.g., repetition factor=8), and the UE 104 does not receive the Msg4, the UE 104 may adjust the transmission timing of the Msg3 PUSCH according to another value of the TA commands and re-transmit the Msg3 PUSCH.

In some embodiments, the UE 104 may select a TA command based on one or more measurement thresholds (e.g., SS-RSRP). The measurement thresholds may be defined or configured to the UE 104. For example, if there are N potential values of TA command, N-1 measurement thresholds can be defined or configured to the UE. If a measurement result is lower than or no higher than the measurement threshold, then the TA command that is associated with the larger measurement (e.g., a value closest to the measurement threshold) may be used for determining the transmission timing of the Msg3 PUSCH. If the measurement result is higher than or no lower than the measurement threshold, the TA command that is associated with the lower value may be used for determining the transmission timing of the Msg3 PUSCH.

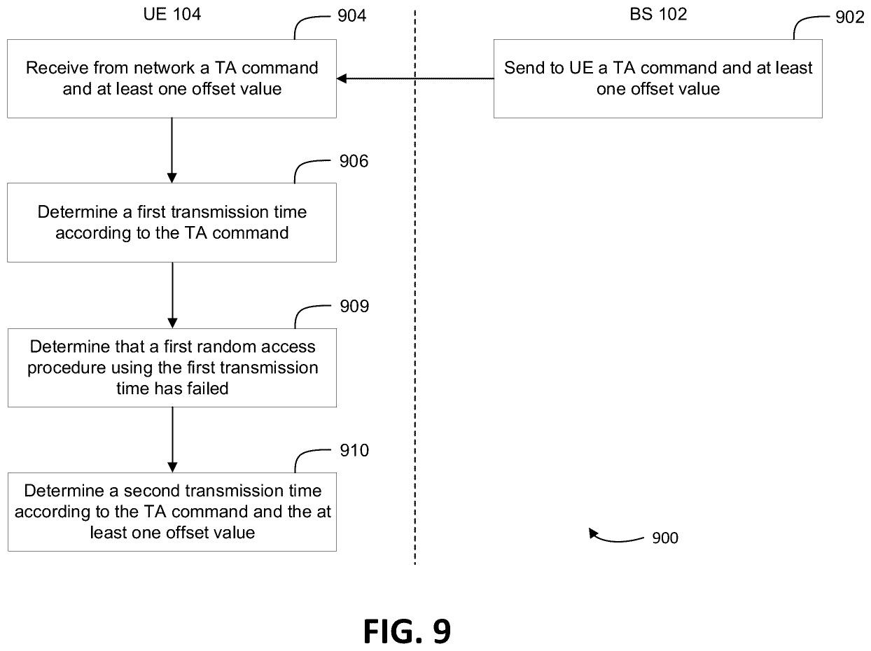

FIG. 9 is a diagram illustrating an example wireless communication method 900, according to various arrangements. In some cases, the method 900 may include configurations for the UE 104 to receive a TA command and at least one offset value. If the UE 104 can determine more than one TA command value, the UE 104 can transmit more than one Msg3 PUSCH before receiving a Msg4.

In some embodiments, at least one offset value may be associated with a TA command value and can be configured by system information (e.g., SIB1). The TA command may be indicated in a RAR. For example, at 902, a BS 102 may send, to the UE 104, a RAR including the TA command and a SIB including the at least one offset value. At 904, the UE 104 may receive, from the BS 102, the TA command and the at least one offset value corresponding to the TA command. At 906, the UE 104 can determine a first transmission timing of an uplink transmission (e.g., a Msg3 PUSCH) according to the value of the TA command (e.g., TA 1) indicated in the RAR. At 908, the UE 104 may determine that a first RACH procedure using the first transmission timing has failed. Responsive to the failure, at 910, the UE 104 may adjust the transmission timing of the uplink transmission (e.g., determine a second transmission timing) according to the TA command and the at least one offset value. For example, the second transmission timing value of the TA command (e.g., TA 2) is derived (e.g., calculated) by adding the TA 1 and one of the at least one offset values.

In some embodiments, the offset value may be predefined. For example, the offset value can be defined as an integer multiple of the preamble length. For example, if Δf_{RA}=15 kHz with a PRACH format of six symbols, potential offset values can be 2048κ·2^{-μ}0.06667 ms, 4096κ·2^{-μ}=0.13333 ms, 6144κ·2^{-μ}=0.2 ms, and 8192κ·2^{-μ}=0.26667 ms.

In some embodiments, a window is defined for the Msg4 PDCCH detection or Msg4 PDSCH reception. After the UE 104 transmits a Msg3 PUSCH, if the UE 104 does not detect a Msg4 PDCCH or receive a Msg4 PDSCH within the window, the UE 104 may determine a Msg3 PUSCH transmission failure (e.g., the Msg3 PUSCH may use a wrong transmission timing).

In some embodiments, one or more measurement thresholds (e.g., SS-RSRP) are defined or configured to the UE 104 for determining which TA command value to use. If there are N potential TA command values, N-1 measurement thresholds can be defined or configured to the UE 104. If the measurement result is lower than or no higher than the measurement threshold, the larger TA command value may be used for determining the transmission timing of the Msg3 PUSCH. If the measurement result is higher than or no lower than the measurement threshold, the smaller TA command value may be used for determining the transmission timing of the Msg3 PUSCH.

In some embodiments, the Msg3 PUSCH repetition is configured. For example, the UE 104 may determine the transmission timing of the Msg3 PUSCH according to one of the TA command values. If the repetition factor of the Msg3 PUSCH transmission is 2 and the UE 104 fails to receive a Msg4 after retransmitting the Msg3 PUSCH transmission up to the repetition factor, the UE 104 can re-transmit the Msg3 PUSCH with a same transmission timing and a repetition factor greater than the previous repetition factor (e.g., repetition factor=4). If the repetition factor of Msg3 PUSCH transmission reaches a maximum value (e.g., repetition factor=8), and the UE 104 does not receive the Msg4, then the UE 104 may adjust the transmission timing of the Msg3 PUSCH according to another TA command value (e.g., to re-transmit the Msg3 PUSCH).

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
receiving, by a wireless communication device from a network, two or more groups of transmission resources for at least one random access procedure;
determining, by the wireless communication device, that a first random access procedure performed using a first transmission resource in a first group of transmission resources of the two or more groups has failed; and
in response to determining that the first random access procedure has failed, performing, by the wireless communication device with the network, a second random access procedure using a second transmission resource in a second group of transmission resources of the two or more groups.

2. The wireless communication method of claim 1, wherein
the first transmission resource comprises a first Physical Random Access Channel (PRACH) transmission resource;
the second transmission resource comprises a second PRACH transmission resource;
the first group of transmission resources comprises a first group of PRACH transmission resources; and
the second group of transmission resources comprises a second group of PRACH transmission resources.

3. The wireless communication method of claim 1, comprising:
selecting, by the wireless communication device, the first transmission resource from the first group of transmission resources; and
switching, by the wireless communication device, from the first group of transmission resources to the second group of transmission resources.

4. The wireless communication method of claim 1, wherein
the first group of transmission resources corresponds to a first value range of Round-Trip-Delay (RTD) or Timing Advancement (TA) command; and
the second group of transmission resources corresponds to a second value range of RTD or TA command, wherein the first value range is different from the second value range.

5. The wireless communication method of claim 1, wherein
the first transmission resource comprises at least one of a first Random Access Channel (RACH) Occasion (RO) resource or a first preamble resource; and
the second transmission resource comprises at least one of a second RO or a second preamble resource.

6. The wireless communication method of claim 1, comprising selecting at least one of the first group of transmission resources or the second group of transmission resources based on one or more measurement thresholds.

7. The wireless communication method of claim 1, wherein determining that the first random access procedure has failed comprises determining that the wireless communication device has failed to detect a Downlink Control Information (DCI) format with a Cyclic Redundancy Check (CRC) scrambled by a Temporary Cell Radio Network Temporary Identifier (TC-RNTI) after the wireless communication device transmitted a Physical Uplink Shared Channel (PUSCH) scheduled by a Random Access Response (RAR) uplink grant.

8. The wireless communication method of claim 1, wherein determining that the first random access procedure has failed comprises determining that a number of times that the first random access procedure has failed reaches a threshold.

9. The wireless communication method of claim 1, wherein determining that the first random access procedure has failed comprises determining that a transmission power used for the first random access procedure reaches a threshold.

10. The wireless communication method of claim 1, wherein determining that the first random access procedure has failed comprises determining that a repetition factor for a transmission used for the first random access procedure reaches a threshold.

11. A wireless communication device, comprising:
at least one processor configured to:
receive, via a receiver from a network, two or more groups of transmission resources for at least one random access procedure;
determine that a first random access procedure performed using a first transmission resource in a first group of transmission resources of the two or more groups has failed; and
in response to determining that the first random access procedure has failed, cause the wireless communication device to perform with the network, a second random access procedure using a second transmission resource in a second group of transmission resources of the two or more groups.

12. The wireless communication device of claim 11, wherein
the first transmission resource comprises a first Physical Random Access Channel (PRACH) transmission resource;
the second transmission resource comprises a second PRACH transmission resource;
the first group of transmission resources comprises a first group of PRACH transmission resources; and
the second group of transmission resources comprises a second group of PRACH transmission resources.

13. The wireless communication device of claim 11, wherein
the first group of transmission resources corresponds to a first value range of Round-Trip-Delay (RTD) or Timing Advancement (TA) command; and
the second group of transmission resources corresponds to a second value range of RTD or TA command, wherein the first value range is different from the second value range.

14. A wireless communication method, comprising:
sending, by a network to a wireless communication device, two or more groups of transmission resources for at least one random access procedure, wherein the wireless communication device fails to perform a first random access procedure using a first transmission resource in a first group of transmission resources of the two or more groups; and
performing, by the network with the wireless communication device, second random access procedure using a second transmission resource in a second group of transmission resources of the two or more groups.

15. The wireless communication method of claim 14, wherein
the first transmission resource comprises a first Physical Random Access Channel (PRACH) transmission resource;
the second transmission resource comprises a second PRACH transmission resource;
the first group of transmission resources comprises a first group of PRACH transmission resources; and
the second group of transmission resources comprises a second group of PRACH transmission resources.

16. The wireless communication method of claim 14, wherein
the first group of transmission resources corresponds to a first value range of Round-Trip-Delay (RTD) or Timing Advancement (TA) command; and
the second group of transmission resources corresponds to a second value range of RTD or TA command, wherein the first value range is different from the second value range.

17. The wireless communication method of claim 14, wherein
the first transmission resource comprises at least one of a first Random Access Channel (RACH) Occasion (RO) resource or a first preamble resource; and
the second transmission resource comprises at least one of a second RO or a second preamble resource.

18. A network node, comprising:
at least one processor configured to:
send, via a transmitter to a wireless communication device, two or more groups of transmission resources for at least one random access procedure, wherein the wireless communication device fails to perform a first random access procedure using a first transmission resource in a first group of transmission resources of the two or more groups; and
cause the network node to perform with the wireless communication device, second random access procedure using a second transmission resource in a second group of transmission resources of the two or more groups.

19. The network node of claim 18, wherein
the first transmission resource comprises a first Physical Random Access Channel (PRACH) transmission resource;
the second transmission resource comprises a second PRACH transmission resource;
the first group of transmission resources comprises a first group of PRACH transmission resources; and
the second group of transmission resources comprises a second group of PRACH transmission resources.

20. The network node of claim 18, wherein
the first group of transmission resources corresponds to a first value range of Round-Trip-Delay (RTD) or Timing Advancement (TA) command; and
the second group of transmission resources corresponds to a second value range of RTD or TA command, wherein the first value range is different from the second value range.
